(19) United States
(12) Patent Application Publication
(10) Pub. No.: US 2009/0247430 A1
(43) Pub. Date: Oct. 1, 2009

(54) Elongated particle breakers in low pH fracturing fluids

(76) Inventor: Diankui Fu, Tyumen (RU)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 12/079,707

(22) Filed: Mar. 28, 2008

(51) Int. Cl. C09K 8/68

(52) U.S. Cl. 507/211; 507/203

(57) ABSTRACT

A method is given for the delayed breaking of a low pH fracturing fluid with acid-generating degradable elongated particles as a breaker for borate-crosslinked polymers. The shape, size, chemical composition and concentration of the elongated particles are used to control the period of delay before the polymer viscosity is broken.

### BACKGROUND OF THE INVENTION

The invention relates to viscosified, low pH fracturing fluids, and to the breaking of such fluids in a fracture after a suitable period of time.

A typical fracturing fluid is prepared by blending a polymer, often a polysaccharide, with an aqueous solution. The purpose of the polymer is to increase the viscosity of the fracturing fluid and to thicken the aqueous solution so that solid particles of proppant can be suspended in the solution for delivery into the fracture. If a crosslinking agent is added to the fracturing treatments, the agent further increases the viscosity of the fluid by crosslinking the polymer. However, when the fluid is viscosified with a polymer, especially a crosslinked polymer, some of the polymer can be left in the fracture after the treatment, which can later inhibit the flow of production fluids out of the formation, through the fracture, into the wellbore, and to the surface for recovery.

During hydraulic fracturing treatments, breakers are commonly used to reduce the fluid viscosity after pumping to allow efficient fracture cleanup. The breakers are normally oxidizing agents that act to shorten the polymer chain structure and one of the most commonly used oxidizers for lower temperature applications is ammonium bisulfate. While this type of breaker works effectively in reducing fluid viscosity, it may produce undesirable solids resulting from the insoluble polymer fragments. In addition, the oxidizing breaker acts primarily on the polymer backbone and is not generally effective in destroying the crosslinking sites.

In addition to fracturing, fluid that comprises a polymer and crosslinker can also be useful in the workover of a hydrocarbon production well to improve production. After the treatment, when it is not desired to allow the gel formed by the workover fluid to remain as a permanent plug, sometimes a breaker is used to intentionally degrade the gel.

Fracturing fluid must be chemically stable and sufficiently viscous to suspend the proppant while it is sheared and heated in surface equipment, well tubulars, perforations and the fracture; otherwise, premature settling of the proppant occurs, jeopardizing the treatment. Crosslinkers join polymer chains for greater thickening, but in certain instances, a delay in crosslinking is advantageous. For example, a delayed crosslinker can be placed downhole prior to crosslinking; the gel fluid is prepared on the surface, then crosslinks after being introduced into a wellbore which penetrates a subterranean formation, forming a high viscosity treating fluid therein. The delay in crosslinking is beneficial in that the amount of energy required to pump the fluids can be reduced, the penetration of certain fluids can be improved, and shear and friction damage to polymers can be reduced. By delaying crosslinking, crosslinkers can be more thoroughly mixed with the polymer fluid prior to crosslink initiation, providing more effective crosslinks, more uniform distribution of crosslinks, and better gel properties.

One way of delaying the cross-linking between the polymer and the boron has been to use a slowly dissolving material such as a slowly dissolving base as in U.S. Pat. No. 3,974,077 to Free, or a slowly dissolving boron-containing material as in U.S. Pat. No. 4,619,776 to Mondshine or U.S. Pat. No. 3,898,165 to Ely. U.S. Pat. No. 5,145,590 to Dawson discloses a solution and method of use for providing controlled delay and improved high temperature gel stability of borated fracturing fluids.

U.S. Pat. No. 6,743,756 to Harris teaches liquid suspensions of particles in non-aqueous liquids such as polyglycol that are said to resist settling or separation of the suspended solids over long periods of time.

U.S. Pat. No. 5,877,127 to Card teaches a method of on-the-fly control of the delay time of aqueous borate-crosslinked polysaccharide based fluids, wherein the fluid is prepared by combining as three separate components, an aqueous solution of the hydrated polysaccharide, an aqueous solution of the boron source and the pH control agent, and an aqueous solution of a polyhydric alcohol which can form equilibrium concentrations of a boron complex. The pre-forming of a specific organo-boron complex is avoided, and instead each of the polysaccharide, boron-complexing agent and the polyol are kept separate until they are combined on-the-fly at the job site. This, the polyol concentration can be controlled to vary the delay time experienced by the fluid. The friction pressure during the job or samples of the as combined fluid can be used to monitor delay time.

It is known that boron cross-linked polymers are sensitive to the pH at which the polymer is crosslinked. When the pH is made more basic, the boron is more inclined to attach itself as a borate ion to a polymer molecule. As the pH becomes more acidic, the boron material tends to stay in the form of boric acid and does not attach itself to the polymer molecule. Though boron may be supplied in a variety of ways, it must be present as borate ions to serve as a crosslinker for polysaccharides, e.g., guar. Boric acid, borate ion and polyions containing various amounts of boron, oxygen, and hydroxyl groups are known to exist in dynamic equilibrium where the percentage of each of the species present is dictated mainly by the pH of the solution. Borate ion begins to dominate the other boron species present in the fluid at a pH of approximately 9.5 and exceeds 95% of total boron species present at a pH of about 11.5. Boron species (including borate ions and boric acid among others) react with di- and poly-hydroxyl compounds having a cis-hydroxyl pair to form complexes, which are in rapid equilibrium with the uncomplexed boron species and the cis-hydroxyl compounds as determined by the equilibrium constants for the specific systems. The equilibrium constant for borate ion is several orders of magnitude larger than the equilibrium constant for boric acid with the same cis-hydroxyl compound. For all practical purposes, borate ions form complexes and thus crosslink polysaccharides, while boric acid does not. Therefore, to have a useable crosslinked polysaccharide fluid with the minimum boron content, much of the boron must be present as borate ions, which requires a crosslink pH of at least about 8.

To avoid confusion, especially in heterogeneous or mixed-phase systems where the polymer and boron source are provided separately and mixed together for preparation of the fluid, as used herein the “crosslink pH” is determined by measuring the immediate equilibrium pH following thorough mixing and any crosslinking in the system at 25° C. The “immediate equilibrium” ignores any slow reactions such as acid release from the fibers that may continue after 5 or 10 minutes post-mixing and/or at elevated temperatures.

An even higher crosslink pH can be required to activate the boron source when it is provided in the form of boric acid rather than as an alkali metal borate, as an example. For example, when the boron compound is added to the hydrated polymer, the crosslink pH can be adjusted up to 12 or more to activate the boric acid by adding a base, such as sodium hydroxide. It is also known to use a pH buffer in borate crosslinking fluid systems. Unless a fluid is adequately buffered, pH may decrease excessively with increasing temperature. For an unbuffered solution prepared with sodium hydroxide having a room temperature pH reading of 12, raising the temperature by 38° C. (100° F.) can decrease the pH by more than 1 unit.

On the other hand, in some borate-crosslinked systems, especially where the quick recovery of high shear-induced viscosity losses is important, it has been known that a crosslink pH that is too high can also delay the time in which the high viscosity can be obtained. In these systems, the crosslink pH should not be higher than about 10.5, preferably not higher than 10. As used herein, the term “low pH” is applied to aqueous borate crosslinked polymer systems with a crosslink pH less than 10.5, preferably less than 10.

Some breaker systems for borate-crosslinked polymers take advantage of the pH sensitivity of the borate crosslinks and use acid to break the gel. The acid can be introduced as flush or separate fluid that mixes with the fracturing fluid after the fracturing job is otherwise completed. It has also been suggested to use encapsulated or slowly releasing acids in the fracturing fluid that delay release of the acid until the fracturing is otherwise completed. However, the use of acid releasing particulates, e.g. polylactic acid (PLA), can be problematic because if the particles are small enough to be dispersed in the fracturing fluid they may have a relative surface area that is too great to avoid releasing the acid too soon. Premature release of the acid can lower the crosslink pH so that crosslinking may be excessively delayed or not occur at all, and the use of acid breakers is particularly problematic in this respect when used in systems that already have a low pH to begin with.

Other references related to borate-crosslinked systems include U.S. Pat. No. 3,215,634 to Walker; U.S. Pat. No. 3,346,556 to Foster; U.S. Pat. No. 3,800,872 to Freidman; U.S. Pat. No. 3,079,332 to Wyant; U.S. Pat. No. 5,082,579 to Dawson; U.S. Pat. No. 5,145,590; U.S. Pat. No. 5,160,643; U.S. Pat. No. 5,160,445 and U.S. Pat. No. 5,310,489 to Sharif; and U.S. Pat. No. 5,372,732 to Harris. Commonly assigned U.S. Ser. No. 11/554917, filed Oct. 31, 2006 by Parris discloses borate crosslinked polymer systems wherein the borate is supplied as a low-viscosity slurry of anhydrous borate solids dispersed in a non-aqueous, non-oily, hygroscopic liquid with a suspension aid.

U.S. Pat. No. 7,021,379 discloses enhancing the consolidation strength of proppant in fractures wherein a resin coating on the proppant particles includes a gel breaker.

U.S. Pat. No. 7,318,475, U.S. Pat. No. 7,219,731, U.S. Pat. No. 7,066,260, U.S. Pat. No. 6,938,693, US 2007-0289743, US 2007-0283591, US 2007-0032386, and US 2006-0157248 relate to the use of dissolvable fibers in filter cakes, fiber assisted proppant transport and/or other degradable fiber applications.

What is needed is an effective way to control the delay the release of the acid using an acid breaker pumped with the borate-crosslinked fluid to avoid affecting the crosslink pH, but to quickly break the crosslinked polymer after the fluid treatment is otherwise completed.

### SUMMARY OF THE INVENTION

The present invention uses degradable elongated particles such as fibers in a low pH borate crosslinked fluid treatment system that can be pumped in the treatment fluid with delayed crosslinking downhole. The elongated particle degradation products lower the pH of the fluid in the formation to break the crosslinked polymer, but do not interfere with delayed crosslinking.

In one embodiment, the present invention provides a method of treating a wellbore and a formation penetrated by the wellbore. The steps of the method can include: (a) preparing an aqueous mixture from a hydrated boron-crosslinkable polymer, a non-aqueous borate slurry and an acid-generating elongated particle breaker, wherein the aqueous mixture has a viscosity at 100 s⁻¹ less than about 100 mPa-s and a crosslink pH in the range from about 8 to about 10.5; (b) injecting the aqueous mixture through the wellbore into the formation under conditions for delayed gelation after the mixture enters the formation; and (c) thereafter generating acid from the elongated particles in an amount effective to reduce the pH and break the gel. In an embodiment, the viscosity of the gel formed in the injection step is from 200 to 800 mPa-s at 100 s⁻¹ and a formation temperature above about 80° C. (176° F.).

In an embodiment, the elongated particle breaker can be selected from the group consisting of substituted and unsubstituted lactide, glycolide, polylactic acid, polyglycolic acid, copolymers of polylactic acid and polyglycolic acid, copolymers of glycolic acid with other hydroxy-, carboxylic acid-, or hydroxycarboxylic acid-containing moieties, copolymers of lactic acid with other hydroxy-, carboxylic acid-, or hydroxycarboxylic acid-containing moieties, mixtures thereof, and the like. Preferably, the fiber breaker comprises polylactic acid that hydrolyzes at a temperature above about 80° C. (176° F.). In an embodiment, the fibers have a length of about 2 to about 25 mm and a denier of about 0.1 to about 20.

In one embodiment of the method, the gel is broken in a period of time from about 0.5 hours to about 100 days following injection.

In various embodiments, the polymer comprises polysaccharide, such as guar in an embodiment. The polymer concentration can be between from about 1.2 g/L (10 lb/1000 gal (ppt)) or 1.8 g/L (15 ppt) up to about 4.8 g/L (40 ppt), preferably between about 2.4 g/L (20 ppt) and about 3.6 g/L (30 ppt).

In one embodiment, the aqueous mixture can include proppant, and in another can be essentially free of inert proppant.

In an embodiment, the aqueous mixture can have a crosslink pH from 9 to 9.5.

In an embodiment, sufficient acid can be generated to lower the pH in the gel below 6.5. The lowering of the pH in the gel can be partially assisted by increasing the temperature of the aqueous mixture in the injection step.

In an embodiment, the borate slurry can include borate hydrate, such as for example, sodium tetraborate decahydrate, or anhydrous borax or a combination of borate hydrate and anhydrous borax. Preferably, less than 10 percent of all boron in the non-aqueous borate slurry is in the form of boric acid. If desired, the borate slurry can include encapsulated borate selected from boric acid and alkali metal borate. In one embodiment, the non-aqueous borate slurry comprises an oil phase. The aqueous mixture can also include a crosslinking delay agent in one embodiment, and polyol in an amount effective to delay crosslinking of the polymer, in another embodiment.

In one embodiment, the aqueous mixture is free of added oxidizer. The method can rely primarily on acid release and pH reduction for breaking the crosslinked polymer.

In various embodiments, the aqueous mixture in the method comprises an emulsion; or alternatively or additionally, foam or energized fluid.

Thus, the present method is directed to an embodiment wherein the injection of a low pH fracturing fluid comprising elongated particles and a viscous carrier fluid, wherein the elongated particles degrade at downhole conditions to further lower the fluid pH and break the viscosity. The fracturing fluid may or may not contain proppant, but if proppant is present in an embodiment, the combination of elongated particle concentration and carrier fluid viscosity can be sufficient to prevent proppant settling during transport even if the carrier fluid viscosity would be insufficient by itself. The elongated particles degrade after the treatment to generate acid and break the viscosity of the carrier fluid.

In yet another embodiment, the fluid is preferably free of added breakers other than the acid-generating elongated particles, especially oxidizers, and in an embodiment, the fluid can contain less than 1 percent, by weight of the polymer, of oxidizers.

### BRIEF DESCRIPTION OF THE DRAWINGS

FIG. 1 shows the viscosity profiles of low-pH borate-crosslinked guar fluids at 95° C. containing polylactic acid (PLA) fibers at 1.2 and 2.4 g/L (10 and 20 lb/1000 gal (ppt)) according to embodiments of the invention.

FIG. 2 shows the viscosity profiles of additional low-pH borate-crosslinked guar fluids at 100° C. containing PLA fibers in the ranges of 0.25 to 3 g/L (1.67 to 25 ppt) according to embodiments of the invention, versus the same fluid without PLA fibers.

FIG. 3 shows the viscosity profiles of additional low-pH borate-crosslinked guar fluids at 90° C. containing PLA fibers in the ranges of 1 to 10 g/L (6.67 to 83.3 ppt) according to embodiments of the invention, versus the same fluid without PLA fibers.

### DETAILED DESCRIPTION OF THE INVENTION

We have found that suitable acid-generating elongated particles can be used as a delayed breaker in low-pH crosslinked polymer fracturing fluids. The present invention will be described primarily in terms of hydraulic fracturing, but it is also suitable for gravel packing, for fracturing and gravel packing in one operation (called, for example frac and pack, frac-n-pack, frac-pack, StimPac treatments, or other names), which are also used extensively to stimulate the production of hydrocarbons, water and other fluids from subterranean formations, or for workovers where it is desired to remove the gel following workover treatment.

Fracturing involves pumping a slurry of proppant (natural or synthetic materials that prop open a fracture after it is created) in hydraulic fracturing or gravel in gravel packing. In low permeability formations, the goal of hydraulic fracturing is generally to form long, high surface area fractures that greatly increase the magnitude of the pathway of fluid flow from the formation to the wellbore. In high permeability formations, the goal of a hydraulic fracturing treatment is typically to create a short, wide, highly conductive fracture, in order to bypass near-wellbore damage done in drilling and/or completion, to ensure good fluid communication between the rock and the wellbore and also to increase the surface area available for fluids to flow into the wellbore.

Gravel is also a natural or synthetic material, which may be identical to or different from proppant. The terms proppant and gravel are synonymous and used interchangeably herein. Gravel packing is used for sand control. Sand is the name given to any particulate material, such as clays, from the formation that could be carried into production equipment. Gravel packing is a sand-control method used to prevent production of formation sand, in which, for example a steel screen is placed in the wellbore and the surrounding annulus is packed with prepared gravel of a specific size designed to prevent the passage of formation sand that could foul subterranean or surface equipment and reduce flows. The primary objective of gravel packing is to stabilize the formation while causing minimal impairment to well productivity. Sometimes gravel packing is done without a screen. High permeability formations are frequently poorly consolidated, so that sand control is needed; they may also be damaged, so that fracturing is also needed. Therefore, hydraulic fracturing treatments in which short, wide fractures are wanted are often combined in a single continuous frac and pack operation with gravel packing. For simplicity, in the following we may refer to any one of hydraulic fracturing, fracturing and gravel packing in one operation (frac and pack), or gravel packing, and mean them all.

The invention is particularly suitable for fracturing tight gas wells, which are typically low-permeability environments with extended fracture closure times; in such cases the fracture may remain open for hours after injection ceases, and the breaking of the carrier fluid may need to be delayed for a relatively long time. The invention is also particularly suitable for gravel packing when dense brines are used that contain high concentrations of calcium or other ions that would precipitate with the degradation products of other degradable fibers (for example up to 12,000 ppm calcium). It is also particularly suitable for situations in which the connate water, that will flow into the fracture after the treatment, is high in such ions as calcium and magnesium. It is also suitable where solids otherwise formed from oxidative breakers might damage the formation.

The following terms will be used in this document: A “treating fluid” or “treatment fluid” is a fluid that is used for treating a well. “Non-oily” describes a composition that passes two key EPA-mandated tests for use in the Gulf of Mexico: EPA Method 1664, Oil and Grease, and EPA Part 435/Appendix A/Subpart 1: Static Sheen. “Essentially free of wax and oil” describes a composition that is generally less than 0.1 weight percent oil, wax or a combination thereof, and to which neither wax nor oil components have been added. “Shear recovery” is the rate of viscosity recovery after high shear; that is, the recovery of viscosity as shearing is ceased.

As used herein, “polymer” may be used to refer to homopolymers, copolymers, interpolymers, terpolymers, and the like. Likewise, a “copolymer” may represent a polymer comprising at least two monomers, optionally with other monomers, and may be a random, alternating, block or graft copolymer. By referring to a polymer as comprising a monomer, it is meant that the monomer is present in the polymer in the polymerized form of the monomer or in the derivative form the monomer.

A “crosslinker” or “crosslinking agent” is a compound such as a borate source which is mixed with a base-gel fluid to create a viscous gel. Under proper conditions, the crosslinker reacts with a multiple-strand polymer to couple the molecules, creating a crosslinked polymer fluid of high, but closely controlled, viscosity.

The term “well” as used in this specification includes the surface site from which a well bore has been drilled to a hydrocarbon-bearing formation and the well bore itself, as well as the hydrocarbon-bearing formation that surrounds the well bore.

The term “hydraulic fracturing” as used in the present application refers to a technique that involves pumping fluids into a well at pressures and flow rates high enough to split the rock and create two opposing cracks extending up to 300 m (1000 feet) or more from either side of the borehole. Later, sand or ceramic particulates, called “proppant,” are carried by the fluid to pack the fracture, keeping it open once pumping stops and pressures decline.

By definition, a “slurry” is a mixture of suspended solids and liquids. The slurry that is used in the composition embodiments of the present invention can be prepared at or near the site of the well bore or can be prepared a remote location and shipped to the site of its intended use. Methods of preparing slurries are known in the art. It is preferred that the slurry be prepared offsite, since this can reduce the expense associated with the transport of equipment, materials and expertise necessary to the preparation of a slurry on site.

The term “mesh” as used in the present application means the Tyler mesh size. The Tyler mesh size is a scale of particle size in powders. The particle size can be categorized by sieving or screening, that is, by running the sample through a specific sized screen. The particles can be separated into two or more size fractions by stacking the screens, thereby determining the particle size distribution.

Solid crosslinking agents suitable in certain embodiments of the present invention are water-reactive and insoluble in a non-aqueous slurry, but become soluble when the slurry is mixed with an aqueous medium. In certain embodiments, the solids will include a slowly soluble boron-containing mineral. These may include borates, such as anhydrous borax and borate hydrate, e.g. sodium tetraborate.

The term “non-aqueous” as used in the present application in one sense refers to a composition to which no water has been added as such, and in another sense refers to a composition the liquid phase of which comprises no more than 1, 0.5, 0.1 or 0.01 weight percent water based on the weight of the liquid phase. The liquid phase of the borate slurry in embodiments can be a hydrocarbon or oil such as naphtha, kerosene or diesel, or a non-oily liquid. In the case of hydrophobic liquids such as hydrocarbons, the solubilization of the borate solids is delayed because the water must penetrate the hydrophobic coating on the solids.

The term “acid generating particles” refers to soluble acids per se, as well as materials that degrade or react with another reactant to form or release acid, either within or outside of the particle.

In one embodiment, the liquid phase of the borate slurry can include a hygroscopic liquid which is generally non-aqueous and non-oily. The liquid can have strong affinity for water to keep the water away from any crosslinking agent, which would otherwise reduce the desired delay of crosslinking, i.e. accelerate the gelation. Glycols, including glycol-ethers, and especially including glycol-partial-ethers, represent one class of hygroscopic liquids. Specific representative examples of ethylene and propylene glycols include ethylene glycol, diethylene glycol, triethylene glycol, propylene glycol, dipropylene glycol, tripropylene glycol, C1 to C8 monoalkyl ethers thereof, and the like. Additional examples include 1,3-propanediol, 1,4-butanediol, 1,4-butenediol, thiodiglycol, 2-methyl-1,3-propanediol, pentane-1,2-diol, pentane-1,3-diol, pentane-1,4-diol, pentane-1,5-diol, pentane-2,3-diol, pentane-2,4-diol, hexane-1,2-diol, heptane-1,2-diol, 2-methylpentane-2,4-diol, 2-ethylhexane-1,3-diol, C1 to C8 monoalkyl ethers thereof, and the like.

In one embodiment, the hygroscopic liquid can include glycol ethers with the molecular formula R—OCH₂CHR¹OH, where R is substituted or unsubstituted hydrocarbyl of about 1 to 8 carbon atoms and R¹ is hydrogen or alkyl of about 1 to 3 carbon atoms. Specific representative examples include solvents based on alkyl ethers of ethylene and propylene glycol, commercially available under the trade designation CELLOSOLVE, DOWANOL, and the like. Note that it is conventional in the industry to refer to and use such alkoxyethanols as solvents, but in the present invention the slurried borate solids should not be soluble in the liquid(s) used in the borate slurry.

The liquid phase of the borate slurry can have a low viscosity that facilitates mixing and pumping, e.g. less than about 50 cP (50 mPa-s), less than about 35 cP (35 mPa-s), or less than about 10 cP (10 mPa-s) in different embodiments. The slurry liquid can in one embodiment contain a sufficient proportion of the glycol to maintain hygroscopic characteristics depending on the humidity and temperature of the ambient air to which it may be exposed, i.e. the hygroscopic liquid can contain glycol in a proportion at or preferably exceeding the relative humectant value thereof. As used herein, the relative humectant value is the equilibrium concentration in percent by weight of the glycol in aqueous solution in contact with air at ambient temperature and humidity, e.g. 97.2 weight percent propylene glycol for air at 48.9° C. (120° F.) and 10% relative humidity, or 40 weight percent propylene glycol for air at 4.4° C. (40° F.) and 90% relative humidity. In other embodiments, the hygroscopic liquid can comprise at least 50 percent by weight in the slurry liquid phase (excluding any insoluble or suspended solids) of the glycol, at least 80 percent by weight, at least 90 percent by weight, at least 95 percent by weight, or at least 98 percent by weight.

If desired, in one embodiment, the borate slurry can also include a suspension aid to help distance the suspended solids from each other, thereby inhibiting the solids from clumping and falling out of the suspension. The suspension aid can include silica, organophilic clay, polymeric suspending agents, other thixotropic agents or a combination thereof. In certain embodiments the suspension aid can include polyacrylic acid, an ether cellulosic derivative, polyvinyl alcohol, carboxymethylmethylcellulose, polyvinyl acetate, thiourea crystals or a combination thereof. As a crosslinked acrylic acid based polymer that can be used as a suspension aid, there may be mentioned the liquid or powdered polymers available commercially under the trade designation CARBOPOL. As an ether cellulosic derivative, there may be mentioned hydroxypropyl cellulose. Suitable organophilic clays include kaolinite, halloysite, vermiculite, chlorite, attapullgite, smectite, montmorillonite, bentonite, hectorite or a combination thereof.

In various embodiments of the present invention, the borate slurry can include crosslinking delay agents such as a polyol compound, including sorbitol, mannitol, sodium gluconate and combinations thereof. The crosslink delay agent can provide performance improvement in the system through increased crosslink delay, enhanced gel strength when the polymer is less than fully hydrated, and enhanced rate of shear recovery. It is preferred that the polyol be present in an amount effective for improved shear recovery. Further, the polyol can be present in an amount that is not effective as a breaker or breaker aid.

In certain embodiments of the present invention, the well treatment fluid comprising the aqueous mixture comprises at least one polymer and at least one borate crosslinker, wherein the polymer and crosslinker can react under proper conditions to produce a crosslinked polymer. The polymer should not prematurely crosslink before the desired set time. The polymer should generally be hydratable, such as a polysaccharide.

Preferred classes of hydratable polymers include galactomannan polymers and derivatized galactomannan polymers; xanthan gums; hydroxycelluloses; hydroxyalkyl celluloses; polyvinyl alcohol polymers (such as homopolymers of vinyl alcohol and copolymers of vinyl alcohol and vinyl acetate); and polymers (such as homopolymers, copolymers, and terpolymers) that are the product of a polymerization reaction comprising one or more monomers selected from the group consisting of vinyl pyrrolidone, 2-acrylamido-2-methylpropanesulfonic acid, acrylic acid and acrylamide, among others. Certain polyvinyl alcohol polymers can be prepared by hydrolyzing vinyl acetate polymers. Preferably the polymer is water-soluble. Specific examples of polymers that can be used include: guar, hydroxypropyl guar (HPG), carboxymethyl guar (CMG), carboxymethylhydroxypropyl guar (CMHPG), hydroxyethyl cellulose, carboxymethylhydroxyethyl cellulose, hydroxypropyl cellulose, hydrolyzed polyacrylamides, copolymers of acrylic acid and acrylamide, xanthan, and mixtures thereof, among others.

Other suitable classes of effective water-soluble polymers (provided that specific examples chosen are compatible with the elongated particles of the invention) include polyvinyl polymers, polymethacrylamides, cellulose ethers, lignosulfonates, and ammonium, alkali metal, and alkaline earth salts thereof. More specific examples of other typical water soluble polymers are acrylic acid-acrylamide copolymers, acrylic acid-methacrylamide copolymers, polyacrylamides, partially hydrolyzed polyacrylamides, partially hydrolyzed polymethacrylamides, polyvinyl alcohol, polyvinly acetate, polyalkyleneoxides, carboxycelluloses, carboxyalkylhydroxyethyl celluloses, hydroxyethylcellulose, other galactomannans, heteropolysaccharides obtained by the fermentation of starch-derived sugar (e.g., xanthan gum), and ammonium and alkali metal salts thereof.

Cellulose derivatives are used to a smaller extent, such as hydroxyethylcellulose (HEC) or hydroxypropylcellulose (HPC), carboxymethylhydroxyethylcellulose (CMHEC) and carboxymethycellulose (CMC), with or without crosslinkers. Xanthan, diutan, and scleroglucan, three biopolymers, have been shown to have excellent proppant-suspension ability even though they are more expensive than guar derivatives and therefore have been used less frequently unless they can be used at lower concentrations.

pH-reversible crosslinking agents based on boron complexes are typically used to increase the effective molecular weight of the polymer and make them better suited for use in high-temperature wells. Boron crosslinked polymers can also be co-crosslinked with titanium, zirconium or aluminum complexes, however, one particular embodiment is essentially free of titanium, zirconium or aluminum complexes that form crosslinks that are irreversible by reducing the pH from 6.5-9.5 down to below 6, preferably below 5.

Some embodiments may further include a delay additive. A delay additive is a material which attempts to bind chemically to borate ions produced by the crosslinker in solution, whereby a hydrated polymer is forced to compete with the delay additive for the borate ions. The effectiveness of the delay additive in chemical bonding can be pH dependent.

Preferably, the delay additive is selected from the group consisting of dialdehydes having about 1 to 4 carbon atoms, keto aldehydes having about 1 to 4 carbon atoms, hydroxyl aldehydes having about 1 to 4 carbon atoms, ortho substituted aromatic dialdehydes and ortho substituted aromatic hydroxyl aldehydes.

Most preferably, the delay additive is selected from the group consisting of dialdehydes having about 2 to 4 carbon atoms, keto aldehydes having about 3 to 4 carbon atoms, hydroxy aldehydes having about 2 to 4 carbon atoms, ortho substituted aromatic dialdehydes and ortho substituted aromatic hydroxyl aldehydes. Preferred delay additives include, for instance, glyoxal, propane dialdehyde, 2-keto propanal, 1,4-butanedial, 2-keto butanal, 2,3-di keto dibutanal, phthaldehyde, salicaldehyde, etc. The preferred delay additive is glyoxal due to its ready availability from a number of commercial sources.

Fracturing fluid compositions used as the aqueous mixture in embodiments of the present method can further comprise other additives. Many of the specialty additives, particularly those used in stimulation or workover, are designed to improve permeability of either the proppant pack or the reservoir rock matrix. Other additives are included to enhance the stability of the fluid composition itself to prevent breakdown caused by exposure to oxygen, temperature change, trace metals, constituents of water added to the fluid composition, and to prevent non-optimal crosslinking reaction kinetics. The choice of components used in fluid compositions of the present invention is dictated to a large extent by the properties of the hydrocarbon-bearing formation on which they are to be used. Such additives that can be selected include a proppant, breaker (in addition to the elongated particle breakers), breaker aid, buffer, stabilizer, thickener, surfactant, corrosion inhibitor, antifoaming agent, preservative or a combination thereof.

Borate slurries in non-aqueous liquids such as oil are available commercially for use in the oil industry. A representative method for making a slurry with a hygroscopic liquid on a commercial production scale can include dispersing, in no particular order, from 0.1 to 75% suspension weight of particlulated water-reactive solids, such as anhydrous borax or borate hydrate, and from 0.1 to 5.0% suspension weight of a suspension aid into from 24 to 99% suspension weight of hygroscopic liquid, such as a glycol ether. The solid particles, suspension agent, and liquid are mixed using conventional agitation, such as an overhead mixer, until the solid particles are uniformly dispersed in the slurry has developed the desired suspension properties. A dry inert atmosphere may be provided to maintain anhydrous conditions.

The slurry should be easily pumpable and pourable, and where it is prepared offsite, remain stable for long periods of time, e.g. 30 days or more, exhibiting minimum separation of liquid and particulate and no packing of the solid particles. The particles suspended in the slurry should disperse in aqueous media better than if the solid is added directly to water. Finally, unlike the direct addition of the unsuspended solids, the particle suspension in the slurry should not create dust upon addition to water.

A more specific embodiment example includes dispersing 40 weight percent anhydrous borax with a grind size of −400 mesh and 2.5 weight percent silica into 57.5 weight percent polyethylene glycol into a mixing vessel with a minimum volume of one liter per kilogram of slurry. The mixture can be agitated using an overhead mixer for a period of one hour. The suspension can be tested for compliance with product specifications by measuring the mixture viscosity on a Brookfield RV viscometer at 20 rpm using a #4 spindle, and observing any supernatant separation, particle packing and other properties as desired by transferring a portion of the contents to a graduated cylinder. If testing results determine that the product specifications have been attained, the slurry can be prepared for storage or shipment. Otherwise, the slurry components can be adjusted as required, and mixed and tested again.

The borate slurry is used as a component of an aqueous mixture used in the well treatment method wherein the slurry crosslinks a hydrated polymer composition after a controlled period of delay. A method for making the aqueous mixture on a commercial production scale can include preparing the slurry as previously described and, if necessary, transporting the slurry to the treatment location. At the treatment site, the aqueous mixture is prepared in one embodiment by blending the hydratable polymer with water in the usual manner along with any proppant or other additives to form a hydrated base fluid. Then, the borate slurry is blended with the hydrated polymer at a weight ratio from 0.01 to 100 parts slurry to 1000 parts hydrated base fluid, preferably from 0.1:1000 to 10:1000, more preferably from 0.5:1000 to 5:1000. Then, the mixture is pumped downhole into the formation.

The borate slurry can be used to control the delay time of a cross-linked fracturing fluid being pumped into a well bore and subterranean formation to be fractured. For fracturing fluids, a polyol component can also be mixed with the slurry at from approximately 1 to 20 percent by weight of the slurry. The polyol can be supplied with the slurry as a preblend, or added separately or with the hydrated base fluid.

Desirably, an adequate supply of conventional pH modifiers are available at the wellsite. Delayed release of pH modifiers (e.g., acids and bases) can be used to initiate crosslinking, to inhibit crosslinking, to assist the elongated particles in destroying crosslinking, or to enhance the stability of crosslinks over broader time and temperature ranges. Buffers and pH modifiers can include sodium hydroxide, magnesium oxide, sodium sesquicarbonate, and sodium carbonate, amines (such as hydroxyalkyl amines, anilines, pyridines, pyrimidines, quinolines, and pyrrolidines, and carboxylates such as acetates and oxalates) and the like. Excessive alkaline buffers should be avoided, however, because this may require excessive elongated particle breaker loadings to achieve polymer degradation in due time. Crosslinking by a borate of certain polymers, e.g., guar polymers, occurs at an alkaline pH as discussed above. While crosslinking of polymers is used to increase viscosity in fracturing fluids, delay of crosslinking is useful to inhibit crosslinking until the fluid composition is in the formation fracture or matrix. In this case it is optimal for the increase in viscosity (e.g., crosslinking) of the fracturing fluid to be delayed until the fluid is about two-thirds down the length of the well bore or further, such that the increase in viscosity of the fluid occurs before the fluid and the proppant reach the fracture entrance.

The breaker elongated particles can be added to the aqueous well treatment mixture after the slurry. Breakers are intended for use in reducing the viscosity of viscous fluids. Certain fracturing fluids used in the methods of the present invention can have a relatively low viscosity as they are pumped into the well bore to the formation, and increase in viscosity as they approach the hydrocarbon-bearing formation. With viscous fracturing fluids, it is often desirable for there to be a subsequent decrease in their viscosity to enhance the flow of production fluids through the established fracture, and the elongated particle breakers can be used to bring about this decrease by releasing acid to lower the pH following the treatment.

The aqueous mixture used as a fracturing fluid can be pumped at a rate sufficient to fracture the formation and to place propping agents into the fracture. A specific embodiment of a fracturing treatment can include hydrating a 0.24 to 0.72% galactomannan based polymer, such as a guar, in a 2% (wt/vol) KCl solution at a pH ranging from about 5.0 to 8.5. The pH can be adjusted with caustic prior to the treatment to provide the desired delay time. During actual pumping, a buffer can be added to increase the hydrated polymer pH to above 8 or 8.5 but not more than 10.5 or 10, preferably about 9.5, followed by addition of the borate slurry and the elongated particles, and typically a proppant. During the treatment, the area close to the well bore will typically begin cooling gradually, resulting in a decreasing gelation rate. The delay time can be easily readjusted to accommodate the cooling, e.g. by acidifying the treatment fluid.

After the fracture is formed and the pumping is terminated, the viscosity of the fluid must be reduced, typically to below about 10 mPa-s. At this viscosity, the fluid can be recovered while leaving the proppant in the fracture. Borate cross-linked galactomannans are pH dependent, requiring an alkaline base fluid having a pH above about 7.8. The elongated particle breaker used in the method, in alkaline water, slowly hydrolyzes to release acid, which decreases the pH of the hydrated polymer gel with time. This in turn reduces the amount of available borate ion, since the borate ion is converted to boric acid which does not cross-link, and thus reduces the viscosity of the fracturing fluid.

Early treatments using fibers to help transport proppant, sometimes called “fiber assisted transport” treatments were typically slickwater (also called waterfrac) treatments (with minimal proppant and a fluid viscosity, for example, of only about 3 mPa-s), as opposed to conventional treatments with crosslinked polymer carrier fluids that typically have viscosities of at least 100 mPa-s, and usually much more. In one embodiment of the invention, the elongated particle beakers in the fluid can allow a lower concentration of crosslinked polymer to be used, for example providing a viscosity of at least about 50 mPa-s, preferably at least about 75 mPa-s, (at 100 sec⁻¹) up to 100 mPa-s, at the temperature at which the fluid is used, especially in stiffer rocks commonly found in tight gas reservoirs, in which the higher viscosity provides increased fracture width. The presence of the elongated particle can de-couple proppant transport characteristics of the fluid from the fluid viscosity. It allows a much lower polymer loading to be used to achieve proppant placement without sacrificing proppant coverage; this means less chance of undesired fracture height growth and reduced fracture damage due to polymer or crosslinked polymer. The viscosity needed depends upon factors such as the stiffness of the rock; the amount, identity, size and stiffness of the elongated particles; the pumping rate and duration; and only to some extent the proppant size, concentration and density. The viscosity needed can be determined by mathematical modeling or by experiments, such as slot flow experiments, known in the industry. Oilfield service companies and contract testing companies can make such determinations.

Suitable materials for the elongated particles of the invention include substituted and unsubstituted lactide, glycolide, polylactic acid, polyglycolic acid, a copolymer of polylactic acid and polyglycolic acid, a copolymer of glycolic acid with other hydroxy-, carboxylic acid-, or hydroxycarboxylic acid-containing moieties, a copolymer of lactic acid with other hydroxy-, carboxylic acid or hydroxycarboxylic acid-containing moieties, or mixtures of the preceding. Other materials suitable for use are all those polymers of hydroxyacetic acid (glycolic acid) with itself or other hydroxy-, carboxylic acid-, or hydroxycarboxylic acid-containing moieties described in U.S. Pat. No. 4,848,467; U.S. Pat. No. 4,957,165; and U.S. Pat. No. 4,986,355, all three hereby incorporated by reference. Suitable materials for the elongated particles used in the invention are also described in US 2003/002195 and US 2004/0152601, both of which are hereby incorporated by reference and are assigned to the assignee of the present application. Other polymers, for example those that degrade at other temperatures, or other pH's, or those that have different chemical compatibilities, may be used, for example polyvinyl alcohol, optionally with suitable carrier fluid adjustment.

Excellent materials for the elongated particles of the invention are solid cyclic dimers, or solid polymers, of certain organic acids, that hydrolyze under known and controllable conditions of temperature, time and pH; the degradation products are organic acids. One example of a suitable material is the solid cyclic dimer of lactic acid (known as “lactide”), which has a melting point of 95 to 125° C., (depending upon the optical activity). Another is a polymer of lactic acid, (sometimes called a polylactic acid (or “PLA”), or a polylactate, or a polylactide). Another example is the solid cyclic dimer of gylycolic acid (known as “glycolide”), which has a melting point of about 86° C. Yet another example is a polymer of glycolic acid (hydroxyacetic acid), also known as polyglycolic acid (“PGA”), or polyglycolide. Another example is a copolymer of lactic acid and glycolic acid. These polymers and copolymers are polyesters. Generally the cyclic dimers are polymerized to form the final polymer from which the elongated particles are made, but for low temperature operations the elongated particles may be made directly from the solid cyclic dimers. The as-received commercially available materials may contain some free acid, for example up to about 5%) and some solvent, typically water.

NatureWorks LLC, Minnetonka, Minn USA, owned by Cargill Inc., Minneapolis, Minn. USA, produces the solid cyclic lactic acid dimer called “lactide” and from it produces lactic acid polymers, or polylactates, with varying molecular weights and degrees of crystallinity, under the generic trade name NatureWorks™ PLA. The PLA's currently available from NatureWorks most commonly have molecular weights of up to about 100,000, although any polylactide (made by any process by any manufacturer) and any molecular weight material of any degree of crystallinity may be used in the embodiments of the Invention. The PLA polymers are solids at room temperature and are hydrolyzed by water to form lactic acid. Those available from NatureWorks typically have crystalline melt temperatures of from about 120 to about 170° C., but others are obtainable. Poly(D,L-lactide) is available from Bio-Invigor, Beijing and Taiwan, with molecular weights of up to 500,000. Bio-Invigor also supplies polyglycolic acid (also known as polyglycolide) and various copolymers of lactic acid and glycolic acid, often called “polyglactin” or poly(lactide-co-glycolide). The rates of the hydrolysis reactions of all these materials are governed, among other factors, by the molecular weight, the crystallinity (the ratio of crystalline to amorphous material), the physical form (size and shape of the solid), and in the case of polylactide, the amounts of the two optical isomers. (The naturally occurring 1-lactide forms partially crystalline polymers; synthetic dl-lactide forms amorphous polymers.) Amorphous regions are more susceptible to hydrolysis than crystalline regions. Lower molecular weight, less crystallinity and greater surface-to-mass ratio all result in faster hydrolysis. Hydrolysis is accelerated by increasing the temperature, by adding acid or base, or by adding a material that reacts with the hydrolysis product(s).

Homopolymers can be more crystalline; copolymers tend to be amorphous unless they are block copolymers. The extent of the crystallinity can be controlled by the manufacturing method for homopolymers and by the manufacturing method and the ratio and distribution of lactide and glycolide for the copolymers. Polyglycolide can be made in a porous form. Some of the elongated particles dissolve very slowly in water before they hydrolyze.

In an embodiment, the dissolvable or degradable elongated particles are free or essentially free of added enzyme breakers such as alpha and beta amylases, exo-and endo-glucosidases, amyloglucosidase, oligoglucosidase, invertase, maltase, cellulase, hemicellulase, endo-xylanase and exo-xylanase. Enzyme breakers are enzymes or combinations of enzymes that attack the glucosidic linkages of the cellulose polymer backbone and degrade the polymer into mostly monosaccharide and disaccharide units. Examples of such enzyme breakers include cellulase, hemicellulase, endo-glucosidase, exo-glucosidase, exo-xylanase and the like. In a particular embodiment, the elongated particles are free or essentially free of exo-and endo-glucosidases.

The elongated particles used in one embodiment of the method of the invention may be coated to slow the hydrolysis. Suitable coatings include polycaprolate (a copolymer of glycolide and epsilon-caprolactone), and calcium stearate, both of which are hydrophobic. Polycaprolate itself slowly hydrolyzes. Generating a hydrophobic layer on the surface of the materials for the elongated particles of the invention by any means delays the hydrolysis. Note that coating here may refer to encapsulation or simply to changing the surface by chemical reaction or by forming or adding a thin film of another material, for example an oil. The degradation does not occur until water contacts the elongated particles. In another embodiment, the outer coating of the core of the elongated particle does not include acetic anhydride and organic and inorganic acids such as fumaric acid, benzoic acid, sulfonic acid, phosphoric acids, aliphatic polyesters, poly lactic acid, poly(lactides), polyanhydrides, poly(amino acids), or the like.

In another embodiment, the degradable materials in the elongated particles are homogenous, i.e. they comprise a continuous phase through the extent of the elongated particle and are not employed as a dispersed phase in a different matrix material, or employed solely as an outer coating or layer in a multilayer composition. In a particular embodiment, the elongated particles do not comprise a gel breaker as a resin coating or portion thereof, or dispersed in a resin coating, of a proppant particle, especially if the gel breaker in the coating is an oxidative breaker, delayed release acid, delayed release enzyme, temperature activated breaker, or hydrolyzable ester. In a preferred embodiment the elongated particles and proppant are discrete components in the aqueous well treating mixture. Supplying the elongated particles separately from the proppants in the same treatment fluid mixtures can have the advantage of controlling the amount of acid generating material that is used and thus the gel break time. Supplying the elongated particles in a separate fluid from the proppant slurry can also allow the gel breaker system to be used in a pad or tail stage without proppant in advance of, between or after proppant-containing stages.

In a further embodiment, the degradable or dissolvable materials are in direct contact with a fluid phase in the aqueous mixture, that is to say they are not coated with a water soluble sold material or another solid encapsulating material that regulates the release of the acid generating breaker; rather, in this embodiment, the solubility or degradation rate of the dissolvable or degradable material itself is the regulating mechanism. In particular in this embodiment, the elongated particles are not coated with a material such as polyvinyl alcohol, polylactic acid, EPDM rubber, polyvinylidene chloride, nylon, waxes, polyurethanes, cross-linked partially hydrolyzed acrylics and surfactants, wherein the coating material is dissimilar to the acid generating material.

The elongated particles self-destruct in situ, that is, in the location where they are placed. Although normally that is in a proppant pack in a fracture, that location may also be part of a suspension in the wellbore, in perforations, in a gravel pack, as a component of a filter cake on the walls of a wellbore or of a fracture, or in natural fractures or vugs in a formation. The elongated particle/polymeric viscosifier system may be used in carbonates and sandstones. A particular advantage of these materials is that the elongated particles of the invention and the generated acids are non-toxic and are biodegradable.

The degradable or dissolvable materials in the elongated particles may be in any shape having one or two dimensions longer than the other two or one dimension(s), respectively: for example, chips, fiber, bead, ribbon, platelet, film, rod, strip, spheroid, toroid, pellet, tablet, capsule, shaving, any round cross-sectional shape, any oval cross-sectional shape, trilobal shape, star shape, flat shape, rectangular shape, cubic, bar shaped, flake, cylindrical shape, filament, thread, or mixtures thereof. In one embodiment, the elongated particles have a relatively low surface area per unit mass compared to small, non-elongated particles such as spheres or cubes. The degradable or dissolvable materials are solid materials, either amorphous or/and crystalline in nature, and generally are not liquid materials.

Material densities are not critical, and will preferably range from below about 1 to about 4 g/cm³ or more. The materials may be naturally occurring and synthetically prepared, or mixture thereof. These degradable or dissolvable materials may even be biodegradable or composed of synthetic organic polymers or elastomers, as well as particular inorganic materials, or any mixtures of such materials. The degradable or dissolvable materials are preferably present in the treatment fluid as a finely divided or dispersed material, while not used as a bulk phase or solid bulk form. Some embodiments may use degradable or dissolvable materials in the form of fibers. As employed herein, the term “fibers” refers to bodies or masses, such as filaments, of natural or synthetic material(s) having one dimension longer than the other two, which are at least similar in size, and further includes mixtures of such materials having multiple sizes and types. The fibers may have a length of about 2 to about 25 mm, preferably about 3 to about 18 mm. Typically, the fibers have a denier of about 0.1 to about 20, preferably about 0.15 to about 6. The fibers preferably degrade under downhole conditions in a duration that is suitable for the selected operation. The fibers may have a variety of shapes ranging from simple round or oval cross-sectional areas to more complex shapes such as trilobe, figure eight, star-shape, rectangular cross-sectional, or the like. When fibers are used, preferably, generally straight fibers with round or oval cross sections will be used. Curved, crimped, branched, spiral-shaped, hollow, fibrillated, and other three dimensional fiber geometries may be used. Again, the fibers may be hooked on one or both ends. Suitable fibers have a length of about 2-25 mm, preferably about 3-18 mm, most preferably about 6 mm; they have a denier of about 0.1-20, preferably about 0.15-6, most preferably about 1.4. Such fibers are optimized for particle transport.

Reference is made hereinafter to elongated particles comprising fibers as an illustrative embodiment and not by way of limitation, the following discussion applying also to elongated particles other than fibers. Because the fibers degrade to release acid which works as a breaker, borate crosslinked polymer systems are particularly preferred. These preferred fluids are sensitive to the release of acid that accompanies the degradation of the fibers. The preferred borate crosslinked fluids have relatively low crosslink pH (as previously defined), for example below about 10.5 down to about 8.5. Degradation of 0.25 to 10 g/L of fibers, for example, will further decrease the pH so that the borate crosslinks are hydrolyzed or broken, e.g. at a pH from about 4.0 to about 6.5. Conversely, the rate of degradation of PLA is lowest at about a pH of 5; it increases at lower and higher pH's, increasing faster at higher pH's than at low. The fibers also degrade faster at higher temperatures. The fiber described in Example 1 below has an expected downhole life of about 5 to 6 hours at a pH of 6.5 to 9.5 at 121° C. (250° F.). At a pH of about 12, the fiber has an expected downhole life of about 5 to 6 hours at 104° C. (220° F.) and of about 15 to 18 hours at about 93° C. (200° F.). Preferably, the fibers degrade in a time at formation temperature at the low pH conditions of from about 4 hours to about 100 days. Triethanolamine stabilizes the fluids to the acid released from the fibers up to a concentration of about 0.2 volume percent (2 gpt) of an 85% triethanolamine solution in water. Another reason why these fluids are preferred is that it is better to use delayed fluids with fibers, because fiber dispersion in water is better before crosslinking.

One embodiment of a metal-crosslinked polymer system in the present method is a boron crosslinked guar designed for delayed crosslinking and optimized for low pH conditions. It is made for example with a guar or guar slurry, anhydrous borax and/or borate hydrate, sodium hydroxide, and sorbitol as a stabilizer/delay agent; it may contain clay stabilizers such as potassium chloride or tetramethylammonium chloride, additional stabilizers such as sodium thiosulfate (usually obtained as the pentahydrate) and triethanolamine, bactericides, breakers, and breaker aids. A particularly preferred example of this fluid, used for example at temperatures below about 110° C. (about 230° F.) is made with about 3.6 g/L (30 ppt or pounds per thousand gallons) guar; 2 L/1000 L (2 gpt) of a 50% tetramethyl ammonium chloride solution in water; 1 L/1000 L (1 gpt) of a non-emulsifying agent containing about 30 to 50% of a blend of alkoxylated polyols, resins, and hydrocarbon solvents in methanol, propan-2-ol and xylene; 2 L/1000 L (2 gpt) of a surfactant containing a mixture of about 15% ethoxylated C₁₁ to C₁₅ linear and branched alcohols in water, isopropanol and ethylene glycol monobutyl ether; 4 mL/L (4 gpt) borate slurry containing about 50% borate and 50% of mineral oil; and 2 L/1000 L (2 gpt) of an 85% triethanolamine solution in water. The fluid may optionally also contain, but in one embodiment is preferably free of added breaker such as, but not limited to, ammonium persulfate or sodium bromate. This formulation is for example used at a guar concentration of about 2.4 g/L (about 20 ppt) to about 4.8 g/L (about 40 ppt) with the amounts of additives listed above; preferably for example at concentrations up to about 3.0 g/L (about 25 ppt) with 1 to 2 L/1000 L (1 to 2 gpt) of the 50% tetra methyl ammonium chloride solution in water; 0-1 L/1000 L (0-1 gpt) of surfactant; 1-2 L/1000 L (1-2 gpt) of the non-emulsifying agent described above; 3.5 mL/L (3.5 gpt) borate in oil slurry; 0-2 L/1000 L (0-2 gpt) of an 85% triethanolamine solution in water.

The preferred concentration of fiber depends on the amount of delay desired for breaking to occur. By adding more fiber, the delay is reduced, and with less fiber the breaking occurs less slowly. The amount of fiber can thus be used in one embodiment to control the breaker delay, e.g. 3 g/L (25 ppt) for delay times of 0.5 to 2.5 hours at temperatures from 90° C. to 100° C.; 1 g/L (8 ppt) for delay times of 1 to >2.5 hours at temperatures from 90° C. to 100° C.; and 0.5 g/L (4.1 ppt) for delay times of 1.3 to >4 hours at temperatures from 90° C. to 100° C. Fiber concentrations are generally independent of proppant concentrations. With these polymer and fiber concentrations, the fluid stability is high enough and the breaker delay is controllable to provide excellent fracture conductivity.

Any proppant (gravel) can be used, provided that it is compatible with the fibers, the formation, the fluid, and the desired results of the treatment. Such proppants (gravels) can be natural or synthetic (including but not limited to glass beads, ceramic beads, sand, and bauxite), coated, or contain chemicals; more than one can be used sequentially or in mixtures of different sizes or different materials. The proppant may be resin coated, preferably pre-cured resin coated, provided that the resin and any other chemicals that might be released from the coating or come in contact with the other chemicals of the Invention are compatible with them. Proppants and gravels in the same or different wells or treatments can be the same material and/or the same size as one another and the term “proppant” is intended to include gravel in this discussion. In general the proppant used will have an average particle size of from about 0.15 mm to about 2.39 mm (about 8 to about 100 U.S. mesh), more particularly, but not limited to 0.25 to 0.43 mm (40/60 mesh), 0.43 to 0.84 mm (20/40 mesh), 0.84 to 1.19 mm (16/20), 0.84 to 1.68 mm (12/20 mesh) and 0.84 to 2.39 mm (8/20 mesh) sized materials. Normally the proppant will be present in the slurry in a concentration of from about 0.12 to about 0.96 kg/L, preferably about 0.12 to about 0.72 kg/L (about 1 PPA to about 8 PPA, for example from about 0.12 to about 0.54 kg/L 1 to about 6 PPA). (PPA is “pounds proppant added” per gallon of liquid.)

Most commonly the fiber is mixed with a slurry of proppant in crosslinked polymer fluid in the same way and with the same equipment as is used for fibers used for sand control and for prevention of proppant flowback, for example, but not limited to, the method described in U.S. Pat. No. 5,667,012. In fracturing, for proppant transport, suspension, and placement, the fibers are normally used with proppant or gravel laden fluids, and can also be used in pads, flushes or the like containing the crosslinked polymer.

Also optionally, the fracturing fluid can contain materials designed to limit proppant flowback after the fracturing operation is complete by forming a porous pack in the fracture zone. Such materials can be any known in the art, such as other fibers, such as glass fibers, available from Schlumberger under the trade name PropNET™ (for example see U.S. Pat. No. 5,501,275). Exemplary proppant flowback inhibitors include fibers or platelets of novoloid or novoloid-type polymers (U.S. Pat. No. 5,782,300). Thus the system may contain a second fiber, for example non-degradable or degradable only at a higher temperature, present primarily to aid in preventing proppant flowback. The fluid of the invention may also contain another fiber, such as a polyethylene terephthalate fiber, that is also optimized for assisting in transporting, suspending and placing proppant, but has a higher degradation temperature and might precipitate calcium and magnesium without preventive measures being taken. Appropriate preventive measures may be taken with other fibers, such as, but not limited to, pumping a pre-pad and/or pumping an acid or a chelating dissolver, adsorbing or absorbing an appropriate chelating agent onto or into the fiber, or incorporating in the fluid precipitation inhibitors or metal scavenger ions that prevent precipitation.

Any additives normally used in such treatments may be included, again provided that they are compatible with the other components and the desired results of the treatment. Such additives can include, but are not limited to anti-oxidants, crosslinkers, corrosion inhibitors, delay agents, biocides, buffers, fluid loss additives, etc. The wellbores treated can be vertical, deviated or horizontal. They can be completed with casing and perforations or open hole.

### EXAMPLE 1

The decomposition rate of a suitable fiber of the invention, a polylactic acid containing about 87 weight % polylactide, about 12 weight % water, and about 1 weight % sizing was determined. The material was NatureWorks™ PLA 6201D or NatureWorks™ PLA 6202D, made into a fiber of average length about 5.7 to 6.3 mm, and denier about 1.35 to about 1.45. It was found that the degradation rate is about the same for 6201D and 6202D. The fiber decomposed in about 1 day at 121° C. (about 250° F.) and at about 2 months at 79.4° C. (about 175° F.).

### EXAMPLES 2-3

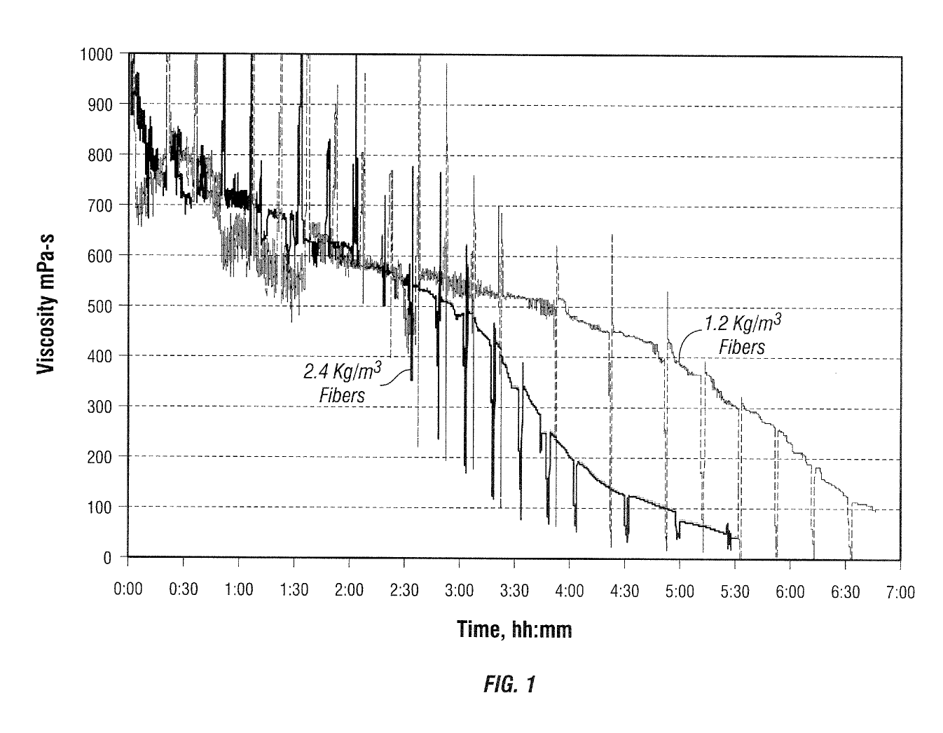

The viscosity of a 3.6 g/L (30 ppt) guar-based fluid with 1 L/m³ (1 gpt) commercial surfactant solution and 2 L/m³ (2 gpt) tetramethyl ammonium chloride solution (clay stabilizer) was determined at 95° C. as a function of time at temperature in a Fann 50 viscometer. The linear gels had a pH of 7.8, a viscosity of 54 mPa-s at 170 l/s, and a viscosity of 28 mPa-s at 511 l/s. In one test, the fluid contained 1.2 g/L (10 ppt) of the fibers used in Example 1, and in another 2.4 g/L (20 ppt). Fluids were made in a Waring blender; in each case, the fluid was made by adding slurried guar to water, hydrating the polymer, then adding other additives, then adding fiber to the linear gel before the crosslinking step, and then adding borate crosslinker (commercial borate slurry in oil). The viscosity profiles are shown in FIG. 1. The fluid with 1.2 g/L fibers had a crosslink pH of 8.62 and after beaking had a viscosity of 15 mPa-s (511 l/s) and pH 4.50; with 2.4 g/L fibers, a crosslink pH of 8.8 and a post-break viscosity of 4 mPa-s and pH 3.54. It is seen that the fluids were effectively broken by the fibers. In contrast the same fluid without the fibers (not shown) regained viscosity upon cooling, indicating that the polymer was not broken.

### EXAMPLES 4-9

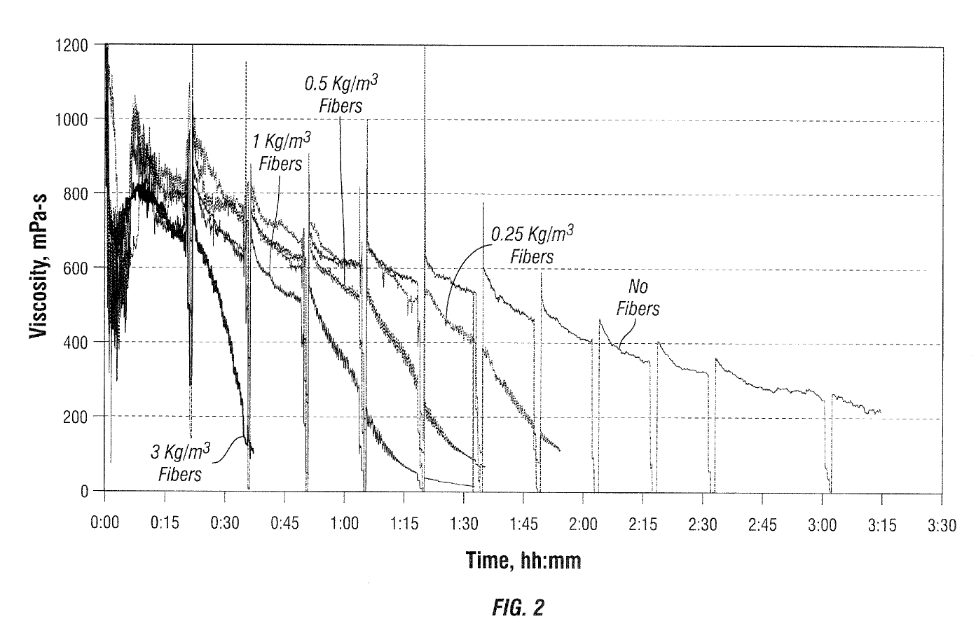

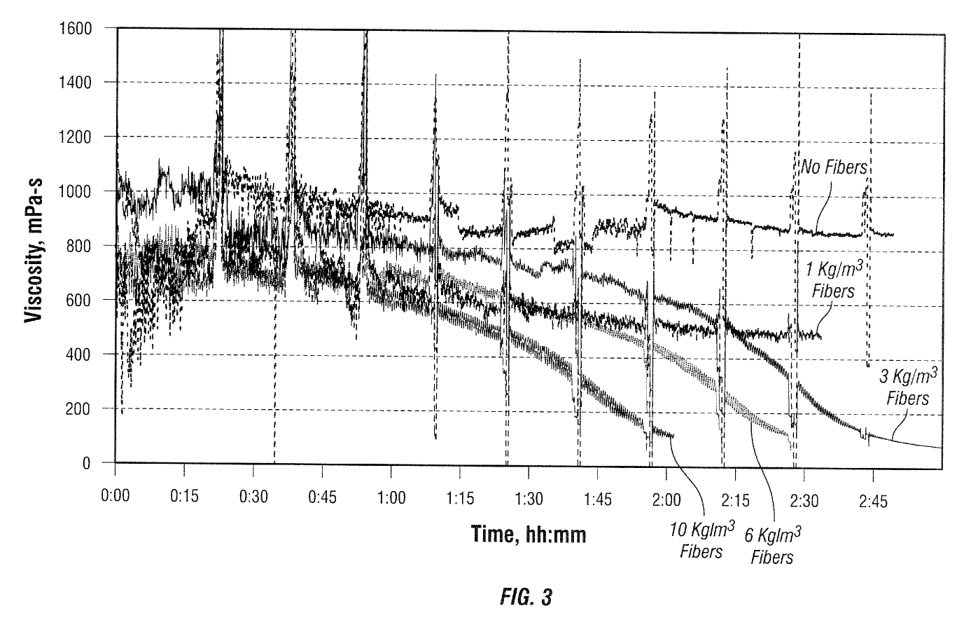

The viscosity of a 3.6 g/L (30 ppt) guar-based fluid with 3 L/m³ (3 gpt) of a solution of clay stabilizer and surfactant and 4 L/m³ (4 gpt) of a borate crosslinker in mineral oil without added fiber was determined at 90° C. and 100° C. as a function of time at temperature in a Fann 50 viscometer. The viscosity of the same fluid with fiber contents of 0.25, 0.5, 1, 3, 6 and/or 10 g/L was similarly observed at 90° C. and/or 100° C., and the viscosity profiles are shown in FIGS. 2 and 3 with the fiber free fluids. The relative stability is indicated in the following table:

| | | |
|---|---|---|
| Fiber content, kg/m3 | 400 mPa-s, hh:mm | 100 mPa-s, hh:mm |

STABILITY TIME AT 100° C.

| | | |
|---|---|---|
| none | 2:15 | 3:30 |
| 0.25 | 1:30 | 2:00 |
| 0.50 | 1:50 | 1:40 |
| 1.00 | 1:00 | 1:15 |
| 3.00 | 0:30 | 0:35 |

STABILITY TIME AT 90° C.

| | | |
|---|---|---|
| none | >2:45 | |
| 1.00 | >2:30 | |
| 3.00 | 2:15 | 2:45 |
| 6.00 | 2:00 | 2:20 |
| 10.00 | 1:30 | 1:50 |

It is seen that the fluids were effectively broken by the fibers, and that the break time can be controlled by selection of the amount of fiber used, depending on the temperature.

Although the methods and compositions of the invention have been described primarily in terms of stimulation of hydrocarbon producing wells, it is to be understood that the invention may be applied to wells for the production of other materials such as water, helium and carbon dioxide and that the invention may also be applied to stimulation of other types of wells such as injection wells, disposal wells, and storage wells.

The invention may be applied to any type of well, for example cased or open hole; drilled with an oil-based mud or a water-based mud; vertical, deviated or horizontal; with or without sand control, such as with a sand control screen. Other treatments may be performed before or after the treatment of the invention, for example scale inhibition, matrix treatment, killing, lost circulation control, injection of spacers, pushers, pre-flushes, post-flushes, etc. The treatment of the invention may be through coiled tubing. In other words, the chemistry, configuration, tools, etc. used in drilling and completion and other treatments before or after the application of the invention are not critical, provided that any fluids used or encountered do not interfere with the fluids and materials used in the invention; this may be checked readily by simple laboratory or simulation experiments in which the potential interactions are tested under expected conditions to ensure that there are no deleterious effects.

Having thus described our invention, we claim:

1. A method of treating a wellbore and a formation penetrated by the wellbore comprising the steps of:
a. preparing an aqueous mixture from a hydrated boron-crosslinkable polymer, a non-aqueous borate slurry and an acid-generating elongated particle breaker, wherein the aqueous mixture has a crosslink pH in the range from about 8 to about 10.5 and a viscosity at 100 s⁻¹ less than about 100 mPa-s;
b. injecting the aqueous mixture through the wellbore into the formation under conditions for delayed gelation after the mixture enters the formation;
c. thereafter generating acid from the fibers in an amount effective to reduce the pH and break the gel.

2. The method of claim 1 wherein the viscosity of the gel formed in the injection step is from 200 to 800 mPa-s at 100 s⁻¹ and a formation temperature above about 80° C. (176° F.).

3. The method of claim 1 wherein the elongated particle breaker is selected from the group consisting of substituted and unsubstituted lactide, glycolide, polylactic acid, polyglycolic acid, copolymers of polylactic acid and polyglycolic acid, copolymers of glycolic acid with other hydroxy-, carboxylic acid-, or hydroxycarboxylic acid-containing moieties, copolymers of lactic acid with other hydroxy-, carboxylic acid-, or hydroxycarboxylic acid-containing moieties, and mixtures thereof.

4. The method of claim 1 wherein the elongated particle breaker comprises polylactic acid that hydrolyzes at a temperature above about 80° C. (176° F.)

5. The method of claim 1 wherein the elongated particles comprise fibers having a length of about 2 to about 25 mm and a denier of about 0.1 to about 20.

6. The method of claim 1 wherein the gel is broken in a period of time from about 0.5 hours to about 100 days following injection.

7. The method of claim 1 wherein the polymer comprises polysaccharide.

8. The method of claim 1 wherein the polymer comprises guar.

9. The method of claim 1 wherein the polymer concentration is between about 1.8 g/L (about 15 ppt) and about 4.8 g/L (about 40 ppt).

10. The method of claim 1 wherein the aqueous mixture further comprises proppant.

11. The method of claim 1 wherein the aqueous mixture is essentially free of proppant.

12. The method of claim 1 wherein the mixture comprises an initial pH from 9 to 9.5.

13. The method of claim 1 wherein sufficient acid is generated to lower the pH in the gel below 6.5.

14. The method of claim 13 wherein the lowering of the pH in the gel is partially assisted by increasing the temperature of the aqueous mixture in the injection step.

15. The method of claim 1 wherein the borate slurry comprises sodium tetraborate decahydrate.

16. The method of claim 1 wherein less than 10 percent of all boron in the non-aqueous borate slurry is in the form of boric acid.

17. The method of claim 1 wherein the borate slurry comprises encapsulated boric acid or alkali metal borate.

18. The method of claim 1 wherein the non-aqueous borate slurry comprises an oil phase.

19. The method of claim 1 wherein the aqueous mixture further comprises a crosslinking delay agent.

20. The method of claim 1 wherein the aqueous mixture comprises polyol in an amount effective to delay crosslinking of the polymer.

21. The method of claim 1 wherein the aqueous mixture is free of added oxidizer.

22. The method of claim 1 wherein the aqueous mixture comprises an emulsion.

23. The method of claim 1 wherein the aqueous mixture comprises foam or energized fluid.
